(19) United States
(12) Patent Application Publication
(10) Pub. No.: US 2005/0016598 A1
(43) Pub. Date: Jan. 27, 2005

(54) Pressure-operated regulating valve with adjustable deadband

(76) Inventor: Timothy Geoffrey Frindt, Vancouver (CA)

Correspondence Address: TIMOTHY FRINDT, P.O. BOX 55028 STN CADBORO BAY, VICTORIA, BC, V8N 6L8, CA

(21) Appl. No.: 10/623,452

(22) Filed: Jul. 21, 2003

(51) Int. Cl. F16K 15/00

(52) U.S. Cl. 137/528

(57) ABSTRACT

A pressure-operated regulating valve for controlling fluid pressure in a conduit. The valve comprises a flexible diaphragm dividing the interior volume of a housing into a control pressure chamber and an outlet chamber. A valve seat connects with the fluid conduit containing pressurized fluid. A disc poppet, which cooperates with the valve seat to control communication between the valve seat and the outlet chamber, is attached to the diaphragm. The valve seat is threaded into the housing so that the valve seat is movable perpendicular to the diaphragm. The diameter of the roll of the diaphragm changes when the valve seat is adjusted, making the effective area of the diaphragm selectively variable. The deadband, or the leakage of the valve can then be adjusted, making the valve useful in fluid measurement and metering systems.

### FIELD OF THE INVENTION

This invention relates to a pressure-operated valve for regulating the pressure in a conduit depending on the magnitude of a control pressure. The invention further relates to a direct-response pressure-operated valve which is actuated by a flexible diaphragm where the effective area of the diaphragm is adjustable.

### BACKGROUND OF THE INVENTION

It is desirable to have a pressure-operated regulating valve that can be closed by a control signal without any leakage and opened without any control signal deadband.

Conventional pressure-operated valves generally include two actuators which produce forces that oppose each other. One actuator closes a valve-closing member and is responsive to the control pressure. The other actuator opens the valve-closing member and is responsive to the pressure in the conduit which is upstream of the valve-closing member. Each actuator has an effective area that the pressures bear against. To achieve the desired relationship between the control pressure and the regulated pressure it is necessary to construct the valve with the appropriate ratio of effective areas.

Numerous patents disclose pressure-operated regulating valves, such as U.S. Pat. No. 4,130,266 by Bertling, U.S. Pat. No. 1,777,6111 by Grohek and U.S. Pat. No. 669,669 by Squires. It is the purpose of pressure-operated valves of this type to regulate the pressure in a fluid conduit which is upstream of the regulating valve. The pressure is regulated to a value which is equal to the magnitude of a control pressure, or to a value which is some constant multiple of a control pressure. These valves are used, for example, in systems where it is required that the pressure in one branch of a system follows the pressure in a control branch for the purposes of flow measurement, as envisioned in U.S. Pat. No. 3,882,723 by Wickham.

In fluid control systems, problems can arise when the system requires a control valve to close completely. The control function can become non-linear if there is valve leakage or deadband, causing poor performance of the fluid control system. Lack of complete sealing of the valve occurs if the effective area of the valve-closing actuator is undersized relative to the valve-opening actuator. Deadband, a range of control signal values over which the valve produces no response, occurs if the situation is reversed-the valve remains closed even though the control pressure directs the valve to open. Also the existence of other non-control forces acting on the valve, such as sliding seals, may also cause similar problems. Pressure-operated valves with either leakage or deadband problems are unsuitable for precision fluid metering and measurement systems.

### SUMMARY OF THE INVENTION

An object of this invention is to provide a pressure-operated regulating valve where the effective area of one actuator is adjustable, so that deadband, and leakage can be eliminated by adjustment of the valve.

Another object of this invention is to provide a pressure-operated regulating valve where the effective areas of the actuators are substantially equal.

The invention comprises a reciprocating poppet valve, actuated by a flexible circular diaphragm which communicates with a chamber of pressurized control fluid. The diaphragm presses against a diaphragm follower which forces the poppet against the seat, closing the valve. The pressure in a conduit, upstream of the valve seat, bears directly on the poppet, forcing the valve to open. Fluid, supplied by the conduit, flows from the valve seat, past the poppet and into a chamber downstream of the poppet. The outer diameter of the diaphragm, the diameter of the diaphragm follower and the diameter of the seal of the valve seat are chosen so that the opposing forces produced by the preselected control pressure and by the pressure in the conduit are substantially equal when the valve is just closed, thus substantially eliminating leakage or deadband.

The adjustment of valve is as follows. Those skilled in the art will know that the effective area of a flexible diaphragm clamped at the rim and subjected to a pressure differential can be estimated to a high degree by taking the effective diameter of the diaphragm to be the crest of the roll of the diaphragm. Lofink discloses in U.S. Pat. No. 2,950,739 a device which uses this principle. When the diaphragm follower and the outer rim of the diaphragm are co-planar, the effective diameter can be taken to be the average of the diameter of the diaphragm follower and the diameter of the rim of the diaphragm. Furthermore, when the diaphragm follower moves axially, the crest of the roll moves radially, and the effective area of the diaphragm changes. In the present invention, this principle is used to advantage in that the axial position of the valve seat is adjustable relative to the diaphragm rim. The valve seat is threaded into the valve housing so that the valve seat can be-screwed in or out, allowing the zero-flow position of the valve to be set.

Those skilled in the art will know that, for poppet lifts less than about 20% of the maximum lift, the effective area of a disc poppet, where the direction of flow is from the valve seat and past the poppet, is practically constant. This is not the case for conical and spherical poppets. As a result, in the present invention, the poppet is a disc so that the effective area is practically constant for small lifts. Also, the diameter of the valve seal is as large as practical, so that the lift of the poppet is small. This minimizes changes in the effective areas of the poppet and the diaphragm when the poppet lifts.

The sealing element of the present invention is attached to the poppet rather than the seat. This is because the axial and parallel alignment of the diaphragm relative to the sealing element of the valve is important for optimal operation of the valve. As a result, the poppet and diaphragm follower element is the only component that requires accurate manufacture, resulting in lower cost.

The valve sealing element is an o-ring whose size and material is chosen so that the sealing force is small relative to the valve actuation forces. When the valve is closed, the sealing force of the o-ring constitutes an extra force on the poppet, resulting in a small discrepancy between the force closing the valve and the force opening the valve. A larger diameter o-ring results in larger valve actuation forces, making this discrepancy insignificant even for small flow rates.

Also in the present invention, when the effective areas of the diaphragm and the poppet are equal, pressure in the chamber downstream of the valve produces no net force on the movable valve element, making the operation of the valve independent of pressure downstream of the valve.

### BRIEF DESCRIPTION OF THE DRAWINGS

FIG. 1 illustrates a cross-sectional view of a preferred embodiment of a pressure-operated regulating valve in accordance with the present invention;

FIG. 2 depicts the net pressures on the diaphragm and valve element of the pressure-operated regulating valve when the effective areas of the diaphragm and the disc poppet are equal.

### DETAILED DESCRIPTION OF THE PREFERRED EMBODIMENT

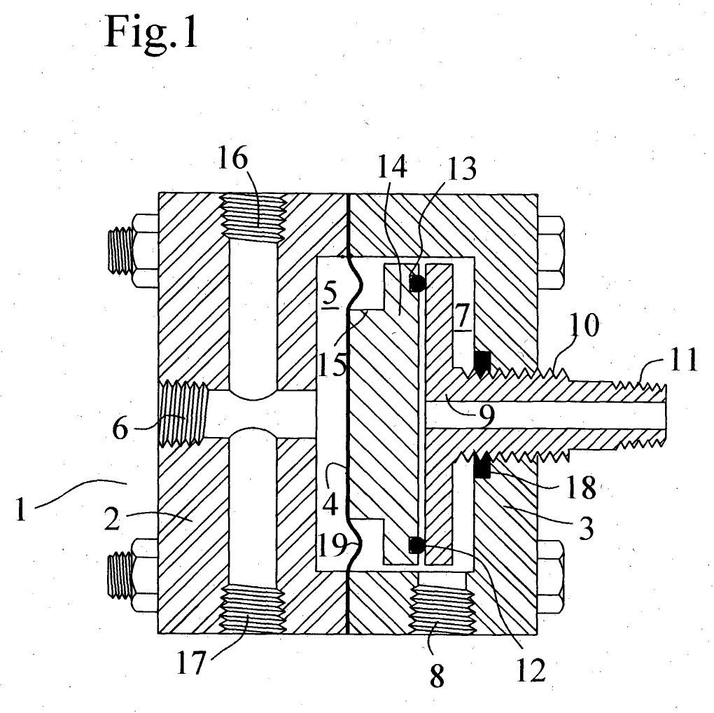

As shown in FIG. 1, the preferred embodiment of the direct-response pressure-operated regulating valve 1 comprises a control chamber housing 2, and an outlet chamber housing 3 which are joined together and between which is clamped a flexible diaphragm 4. The diaphragm 4 and control chamber housing 2 define a control pressure chamber 5 which is supplied with pressurized control fluid through a port 6. Similarly, the diaphragm 4 and outlet chamber housing 3 define an outlet chamber 7 which exhausts through a port 8.

A valve seat 9 threads into outlet chamber housing 3 by a screw thread 10. Valve seat 9 is connected by a fitting 11 to a rotatable connector (not shown) which connects to a pressurized fluid conduit (not shown). A thread seal 18 prevents leakage from screw thread 10. Valve seat 9 cooperates with a disc poppet 14 to restrict the passage of fluid from valve seat 9 into outlet chamber 7. Disc poppet 14 is provided with an o-ring 12, an o-ring groove 13 and a diaphragm follower 15. O-ring 12, which constitutes a resilient sealing means, is secured in o-ring groove 13. Diaphragm 4 is fastened to and presses upon diaphragm follower 15.

Fluid pressure in valve seat 9 bears against disc poppet 14, urging valve seat 9 to open. The effective area of the disc poppet 14 is represented by the projected line of contact between o-ring 12 and valve seat 9. Pressurized fluid in control pressure chamber 5 presses on diaphragm 4 and urges valve seat 9 to close. Diaphragm 4 is provided with an annular roll and crest 19. The effective area of diaphragm 4 is represented by the area of the diaphragm follower 15, plus that annular area of diaphragm 4 that is between the edge of the diaphragm follower 15 and the crest 19 of diaphragm 4. Disc poppet 14 moves until the forces produced by the pressures in valve seat 9 and control pressure chamber 5, are equal. In this way, the pressure in valve seat 9 is regulated by the control pressure in pressure chamber 5.

Screw thread 10 provides a means for moving valve seat 9 perpendicular to diaphragm 4 to provide a means of adjusting the effective area of diaphragm 4. Rotating valve seat 9 so that valve seat 9 moves towards the diaphragm 4, causes the radial location of the crest 19 of diaphragm 4 to increase. As a result, the effective area of diaphragm 4 increases, resulting in a increase in the force closing valve seat 9. In the same way, moving valve seat 9 away from diaphragm 4 decreases the force closing valve seat 9. This adjustment may be necessary to compensate for manufacturing inaccuracies in the sizes of either or all of oaring 12, the diaphragm follower 15 or the outer diameter of diaphragm 4. This adjustment may also be necessary to compensate for any force required to compress o-ring 12 in order to just seal valve seat 9. This adjustment may also be necessary to compensate for any axial or parallel misalignment between o-ring 12, diaphragm follower 15 and the outer diameter of diaphragm 4.

Ports 16 and 17 are for connection to a pressure gauge (not shown) or some other valve (not shown) for the purpose of venting the pressure in control pressure chamber 5. Either or both ports 16 and 17 may also be plugged.

In the preferred embodiment, the effective diameter of diaphragm 4 is very much larger than the lift of disc poppet 14 during operation of the valve. For example, for a valve sized to regulate compressed air in a conduit at a pressure of 60 psi, and at a maximum flow rate of 1 standard cubic foot per minute, the outer diameter of the o-ring 13 may be a nominal 1.0625 inches, the inner diameter of the o-ring 13 a nominal 0.9375 inches, the outer diameter of diaphragm 4 a nominal 1.25 inches and the diameter of diaphragm follower 15 a nominal 0.75 inches. The diaphragm is constructed of 0.0625 inch thick fibre-reinforced rubber. For a valve sized in accordance with the above dimensions, the disc poppet 14 will normally undergo a lift of about than 0.002 inches and the resulting error between control and regulated pressure is about 0 inches of water at no flow, and about 20 inches of water at a flow rate of about 1 standard cubic foot per minute.

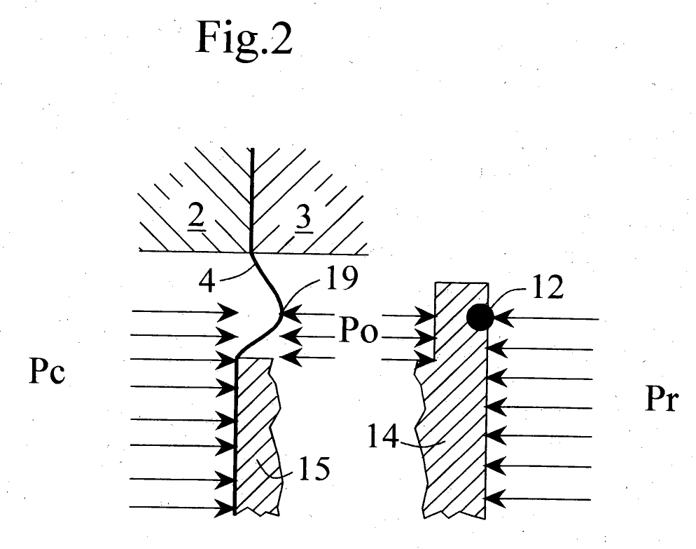

Referring now to FIG. 2, the arrows indicate the net pressures on the movable element of the valve. The control pressure in control pressure chamber 5 is labelled P.sub.c, the regulated pressure in valve seat 9 is labelled P.sub.r, and the pressure in outlet chamber 7 is labelled P.sub.o. A force balance on the disc poppet 14 and diaphragm follower 15 is given by the equation:
P.sub.c*A.sub.f+(P.sub.c−P.sub.o)*(A.sub.e−A.sub.f)=P.sub.r*A.sub.p−P.sub.o*(A.sub.p−A.sub.f)
where A.sub.f is the area of diaphragm follower 15, A.sub.e is the effective area of the diaphragm where the effective diameter is at the crest 19, and A.sub.p is the area of the disc poppet 14 described by the sealing line of o-ring 12 on valve seat 9. If valve seat 9 is rotated so that the crest 19 of the diaphragm is adjusted such that:
A.sub.e.approxeq.A.sub.p, then
P.sub.r.approxeq.P.sub.c,
   and P.sub.o has effectively no influence on the movable valve element, making the operation of the valve substantially independent of pressure downstream of the valve.

Thus, a direct-response pressure-operated regulating valve with adjustable deadband has been disclosed. It is to be understood that the described embodiment is merely, illustrative of some of the many embodiments which represent applications of the principles of the present invention. Clearly numerous and other arrangements can be readily devised by those skilled in the art without departing from the scope of the invention.

1. A direct-response pressure-operated regulating valve including, a housing and flexible diaphragm means in the housing dividing the interior volume into a control pressure chamber and an outlet chamber, a valve seat which is connectable with a fluid conduit containing pressurized fluid, and a valve closing means attached to the diaphragm means to cooperate with the valve seat to control communication between the valve seat and the outlet chamber, whereby pressurized control fluid admitted into the control pressure chamber causes movement of the diaphragm means thereby controlling pressure in the fluid conduit, the improvement comprises;
an adjustment means for moving the valve seat relative to the housing so that the valve seat is movable perpendicular to the diaphragm means whereby the effective area of the diaphragm means is selectively variable.

2. The apparatus of claim 1 wherein the valve closing means comprises a poppet, a resilient sealing means which cooperates with the valve seat and which is fastened to the poppet, and a diaphragm follower which is fastened to the diaphragm means.

3. The apparatus of claim 2 wherein the diaphragm follower and the resilient sealing means are substantially parallel and coaxial.

4. The apparatus of claim 2 wherein the resilient sealing means is an o-ring of predetermined size, and the diaphragm follower is a disc of predetermined diameter.

5. The apparatus of claim 1 wherein the adjustment means is a screw thread.

6. The apparatus of claim 5 wherein leakage from the screw thread is discouraged by a thread sealing means.

7. The apparatus of claim 1 wherein the effective area of the valve-closing means is very much larger than the lift of the valve closing means during operation of the valve.

8. The apparatus of claim 1 wherein the area of the valve-closing means which is acted upon by fluid pressure contained in the fluid conduit is substantially equal to the effective area of the diaphragm means.

9. A method for adjusting the effective area of a direct-response type pressure-operated regulating valve, the method employing a direct-response pressure-operated valve including, a housing and flexible diaphragm means in the housing dividing the interior volume thereof into a control pressure chamber and an outlet chamber, a valve seat in communication with a pressurized fluid conduit, and a valve-closing member attached to the diaphragm means to cooperate with the valve seat to control communication between the fluid conduit and the outlet chamber, whereby pressurized control fluid admitted into the control pressure chamber causes movement of the diaphragm means thereby controlling pressure in the fluid conduit, the improvement comprises;
moving the valve seat perpendicular to the diaphragm means so that the effective area of the diaphragm means is selectively varied.

10. The method of claim 9 wherein the method further comprises adjusting the valve seat so that the forces opening and closing the valve-closing member are substantially equal when the valve just closes.

11. A direct-response pressure-operated regulating valve comprising;
a control chamber housing, an outlet chamber housing and flexible diaphragm means dividing the housings into a control pressure chamber and an outlet chamber,
a valve seat which is connectable with a fluid conduit containing pressurized fluid,
a valve closing means attached to the diaphragm means to cooperate with the valve seat to control communication between the valve seat and the outlet chamber, whereby pressurized control fluid admitted into the control pressure chamber causes movement of the diaphragm means thereby controlling pressure in the fluid conduit,
and an adjustment means for moving the valve seat relative to the housing so that the valve seat is movable perpendicular to the diaphragm means whereby the effective area of the diaphragm means is selectively variable.

12. The apparatus of claim 11 wherein the valve closing means comprises a poppet, a resilient sealing means which cooperates with the valve seat and which is fastened to the poppet, and a diaphragm follower which is fastened to the diaphragm means.

13. The apparatus of claim 12 wherein the diaphragm follower and the resilient sealing means are substantially parallel and coaxial.

14. The apparatus of claim 12 wherein the resilient sealing means is an o-ring of predetermined size, and the diaphragm follower is a disc of predetermined diameter.

15. The apparatus of claim 11 wherein the adjustment means is a screw thread.

16. The apparatus of claim 15 wherein leakage from the screw thread is discouraged by a thread sealing means.

17. The apparatus of claim 11 wherein the effective area of the valve-closing means is very much larger than the lift of the valve closing means during operation of the valve.

18. The apparatus of claim 11 wherein the area of the valve-closing means which is acted upon by fluid pressure contained in the fluid conduit is substantially equal to the effective area of the diaphragm means.
